(19) United States
(12) Patent Application Publication
(10) Pub. No.: US 2026/0180030 A1
(43) Pub. Date: Jun. 25, 2026

(54) METHODS AND SYSTEMS FOR SOLID-STATE BATTERIES

(71) Applicant: Ford Global Technologies, LLC, Dearborn, MI (US)

(72) Inventors: Wenhui Zhu, Northville, MI (US); Minghong Liu, Canton, MI (US); Kent Snyder, Dearborn, MI (US)

(21) Appl. No.: 18/988,377

(22) Filed: Dec. 19, 2024

(51) Int. Cl. H01M 10/058; H01M 10/04

(52) U.S. Cl. CPC H01M 10/058; H01M 10/0463; H01M 10/049; H01M 2300/0085

(57) ABSTRACT

Methods and systems are provided for a solid-state battery. In one example, a solid-state battery includes a solution at least partially filling an overhang area between an anode electrode stack and a cathode electrode stack. The solution is configured to support the anode electrode stack in the overhang area.

### FIELD

The present description relates generally to a reinforced solid-state battery.

### BACKGROUND/SUMMARY

Solid-state batteries may present an alternative to liquid lithium-ion batteries. Solid-state batteries may include solid electrodes and a solid electrolyte material.

The inventors have found a way to further develop performance of solid-state batteries. In one example, a solid-state battery includes a solution at least partially filling an overhang area between an anode electrode and a cathode electrode. In this way, the solution may support and reduce mechanical stress experienced by the anode electrode.

As one example, the solution is applied to at least the overhang area after stacking the electrodes of the solid-state battery together. The application of the solution may be targeted to only the overhang area or more broadly to a greater area of the solid-state battery including at least the overhang area. Excess solution may be removed from one or more areas of the solid-state battery prior to hardening of the solution. By doing this, mechanical stresses experienced by the solid-state battery may be reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 illustrates an example solid-state battery including a solution inserted into an overhang area thereof.

FIG. 2 illustrates a first example process step including applying the solution to the solid-state battery.

FIG. 3 illustrates a second example process step including applying the solution to the solid-state battery.

FIG. 4 illustrates a third example process step including applying the solution to the solid-state battery.

FIG. 5 illustrates a first manufacturing method for introducing the solution to the solid-state battery.

FIG. 6 illustrates a second manufacturing method for introducing the solution to the solid-state battery.

FIG. 7 illustrates a third manufacturing method for introducing the solution to the solid-state battery.

### DETAILED DESCRIPTION

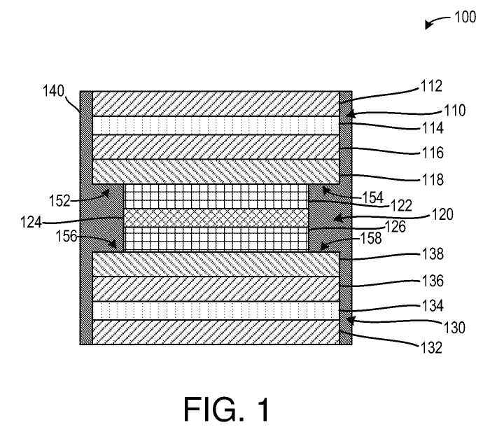

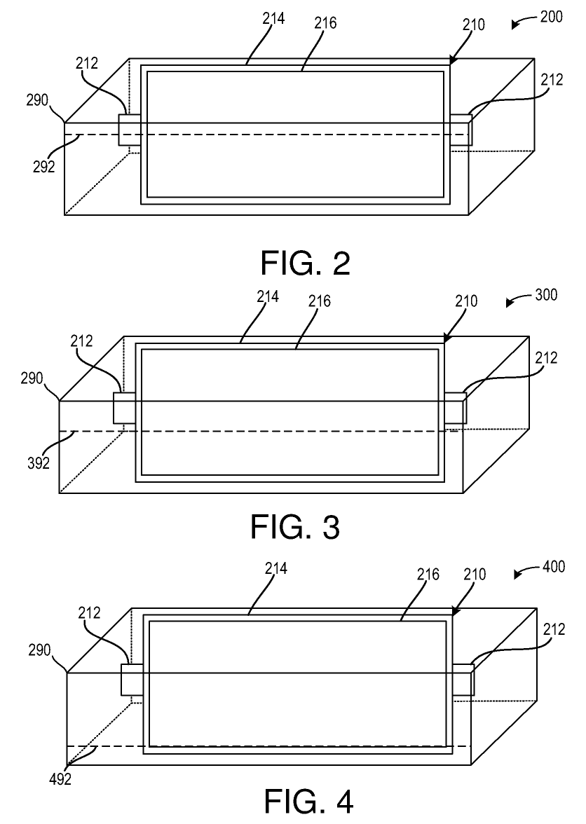

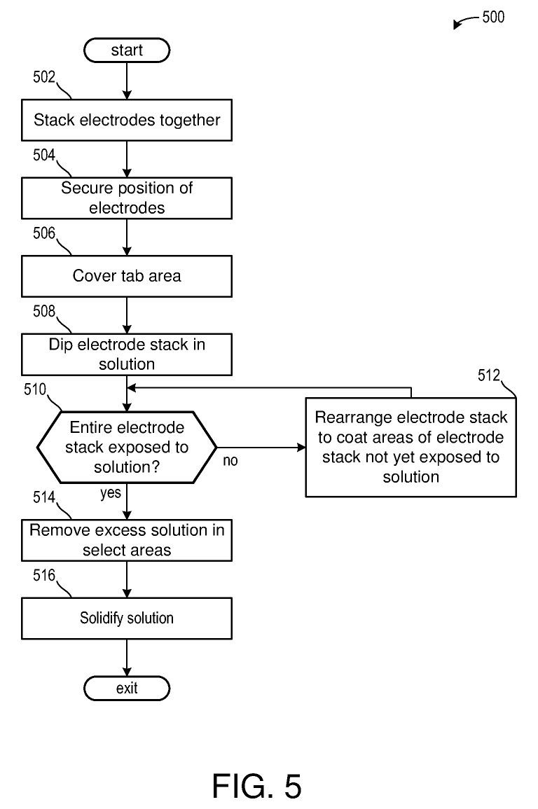

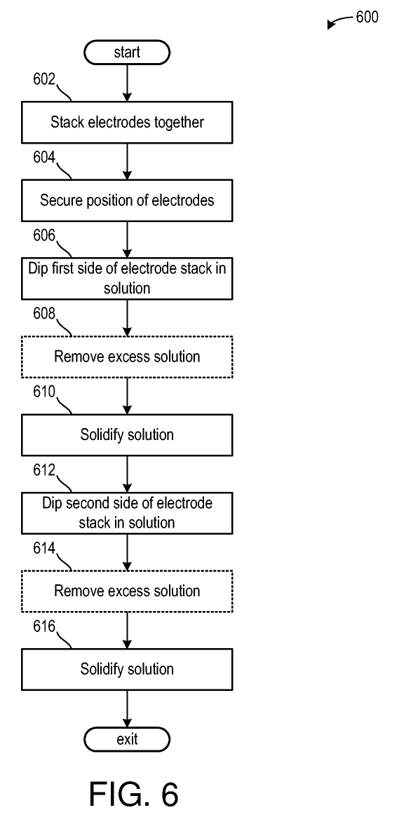

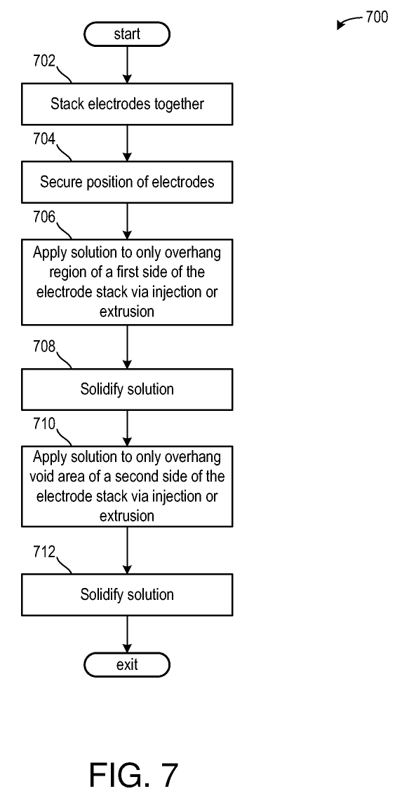

The following description relates to systems and methods for a solid-state battery and manufacture thereof. FIG. 1 illustrates an example solid-state battery including a solution inserted into an overhang area thereof. FIG. 2 illustrates a first example process step including applying the solution to the solid-state battery. FIG. 3 illustrates a second example process step including applying the solution to the solid-state battery. FIG. 4 illustrates a third example process step including applying the solution to the solid-state battery. FIG. 5 illustrates a first manufacturing method for introducing the solution to the solid-state battery. FIG. 6 illustrates a second manufacturing method for introducing the solution to the solid-state battery. FIG. 7 illustrates a third manufacturing method for introducing the solution to the solid-state battery.

FIGS. 1-4 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, it shows an example of a solid-state battery 100. The solid-state battery 100 may include a first anode stack 110, a cathode stack 120, and a second anode stack 130. The cathode stack 120 may be arranged between the first anode stack 110 and the second anode stack 130.

The first anode stack 110 and the second anode stack 130 may be identical to one another in size, shape, and materials included therein. The first anode stack 110 may include a first anode electrode 112, a first current collector 114, and a second anode electrode 116. A first solid-state electrolyte 118 may be positioned between the second anode electrode 116 of the first anode stack 110 and a first cathode electrode 122 of the cathode stack 120. The first current collector 114 may be positioned between and in face-sharing contact with the first anode electrode 112 and the second anode electrode 116. The first solid-state electrolyte 118 may be in face-sharing contact with the second anode electrode 116 and the first cathode electrode 122 of the cathode stack 120. In this way, the first solid-state electrolyte 118 may separate the first anode stack 110 from the cathode stack 120 and function as a separator layer.

The second anode stack 130 may include a third anode electrode 132, a second current collector 134, and a fourth anode electrode 136. A second solid-state electrolyte 138 may be positioned between the fourth anode electrode 136 of the second anode stack 130 and a second cathode electrode 126 of the cathode stack 120. The second current collector 134 may be positioned between and in face-sharing contact with the third anode electrode 132 and the fourth anode electrode 136. The first current collector 114 and the second current collector 134 may comprise copper. The second solid-state electrolyte 138 may be in face-sharing contact with the fourth anode electrode 136 and the second cathode electrode 126 of the cathode stack 120. In this way, the second solid-state electrolyte 138 may separate the second anode stack 130 from the cathode stack 120.

The cathode stack 120 may include a third current collector 124. In one example, the third current collector 124 comprises aluminum. The cathode stack 120 may be positioned between and in face-sharing contact with the first cathode electrode 122 and the second cathode electrode 126.

A dimension of the first anode stack 110 and the second anode stack 130 may be larger than an associated dimension of the cathode stack 120, resulting in an overhang. In one example, the overhang area is one of a plurality of overhangs including a first overhang 152, a second overhang 154, a third overhang 156, and a fourth overhang 158. The first overhang 152 and the second overhang 154 correspond to areas of the first solid-state electrolyte 118 in contact with the second anode electrode 116 but not the first cathode electrode 122. The third overhang 156 and the fourth overhang 158 correspond to areas of the second solid-state electrolyte 138 in contact with the fourth anode electrode 136 but not the second cathode electrode 126. In this way, the plurality of overhangs is associated with areas of the solid-state electrolytes not supported by the cathode stack 120. These areas may be susceptible to increased stress without inclusion of a support 140.

The solid-state battery 100 may include the support 140. In one example, the support 140 may be a gel or a glue that is hardened. The support 140 may include ultraviolet (UV) curable compounds, a solvent based solution, or a material that solidifies below a threshold temperature. The support 140 may be applied to the solid-state battery 100 in a liquid state and solidified via UV light exposure, solvent removal via a drying process, or a temperature reduction process (e.g., a hot melt-based process). Application and processing of the support 140 to the solid-state battery 100 is described in greater detail below.

The support 140 may be non-conductive and in face-sharing contact with the axial surfaces of the first anode stack 110, the second anode stack 130, and the cathode stack 120. In one example, the support 140 contact axial surfaces of each of the first anode electrode 112, the first current collector 114, the second anode electrode 116, the first solid-state electrolyte 118, the first cathode electrode 122, the third current collector 124, the second cathode electrode 126, the second solid-state electrolyte 138, the fourth anode electrode 136, the second current collector 134, and the third anode electrode 132. In some examples, additionally or alternatively, the support 140 may be trimmed such that its thickness is reduced. Additionally or alternatively, the support 140 may be removed from area other than the plurality of overhangs. In this way, the support 140 may at least partially fill or completely fill the overhang area such that the support 140 contacts lateral surfaces of the first solid-state electrode.

As illustrated in FIG. 1, the support 140 may be thicker in the overhang area compared to areas other areas of the solid-state battery 100 coupled to the support 140. Said another way, the support 140 may be thicker at the region associated with the cathode stack 120, solid-state electrolytes, and the plurality of overhangs than at the axial surfaces of the first anode stack 110 and the second anode stack 130.

Turning now to FIG. 2, it shows an example 200 of a processing step including applying a solution to a battery 210. The electrodes of the battery 210 may be secured together via a fastener to prevent movement during application of the solution to the battery 210. In one example, the fastener may include tape, a pouch, or other device. The battery 210 may include a pair of tabs 212. The tabs 212 may be covered via the fastener. Additionally or alternatively, the tabs 212 may be covered via a separate device, such as a removable tape.

The electrode stack, also referred to as a jelly roll, of the battery 210, including the electrodes of an anode portion 214 and a cathode portion 216, may be dipped into the solution. A container 290 may hold the solution. A fill line 292 of the solution in the container 290 may extend to a mid-point of the tabs 212. In this way, a first half of the electrode stack of the battery 210 may be in contact with the solution during the step of FIG. 2. Once the first half of the electrode stack is dipped (e.g., immersed) in the solution, the electrode stack may be flipped to allow a second half of the electrode stack to be immersed in the solution. By doing this, an entirety of the electrode stack may be exposed to the solution. A detailed processing method including the example 200 is described in greater detail with respect to the method 500 of FIG. 5.

Turning now to FIG. 3, it shows an example 300 of a processing step including applying a solution to the battery 210. The example 300 differs from the example 200 in that a fill line 392 of the solution is below the tabs 212. In this way, the tabs 212 may not be covered via a removable tape or other similar element. The electrode stack of the anode portion 214 and the cathode portion 216 may be arranged in the solution such that a first side is coated in the solution. Excess solution may be removed from the first side and then hardened prior to arranging a second side of the electrode stack in the solution. A detailed processing method including the example 300 is described in greater detail with respect to the method 600 of FIG. 6.

Turning now to FIG. 4, it shows an example 400 of a processing step including applying a solution to the battery 210. The example 400 differs from the example 200 and the example 300 in that a fill line 492 allows the solution to only fill an overhang area without extending to the cathode portion 216. In this way, the tabs 212 may not be covered via a removable tape or other similar element and solution may not contact the cathode and the cathode current collector. The electrode stack may be arranged in the solution such that a first side is coated in the solution. Excess solution may be removed from the first side and then hardened prior to arranging a second side of the electrode stack in the solution.

Following application of the solution to the battery 210, the electrode stacks may be sealed in a pouch in each of the examples of FIGS. 2, 3, and 4.

Turning now to FIG. 5, it shows an example method 500 of manufacturing a solid-state battery. At 502, the method 500 may include stacking the electrodes together. As such, the anode electrodes and the cathode electrodes may be stacked and their layers alternately arranged such that the anode electrodes do not contact the cathode electrodes.

At 504, the method 500 may include fixing a position of the electrodes. The position of the electrodes may be fixed via a removable tape, a strap, or other fastening device.

At 506, the method 500 may include covering a tab area. The tab area, including the tabs, may be covered via a removable tape. In this way, the tab area may be sealed from liquids. Optionally, the method may further include covering a portion of the electrode stack. The portion of the electrode stack may be covered with the removable tape or another device to reduce excess solution adhering to the electrode stack. By doing this, a weight savings may be realized. The portion of the electrode stack covered may include a top and/or a bottom of the electrode stack.

At 508, the method 500 may include dipping (e.g., immersing and/or exposing) the electrode stack in the solution. In one example, the solution is a gel. In another example, the solution is a glue.

At 510, the method 500 may include determining if the entire electrode stack has been exposed to the solution. If the entire electrode stack has not been exposed to the solution, then at 512, the method 500 may include rearranging the electrode stack to coat areas of the electrode stack not yet exposed to the solution. In this way, the method may include immersing a first half of the electrode stack in the solution and then immersing a second half of the electrode stack in the solution. The solution on the electrode stack may be optionally solidified after dipping the first half and prior to dipping the second half. Each of the first half and the second half may include a long side, halves of two short sides, and halves of two tabs.

In some examples, additionally or alternatively, the method may include trimming excess solution from the electrode stack and hardening the solution prior to coating areas not yet exposed to the solution.

If the entire electrode stack has been exposed to the solution, then at 514, the method 500 may include removing excess solution in select areas. Select areas may include areas spaced away from the overhand region, such as axial walls of the anode. Removing excess solution may include thinning the solution in the select areas or completely removing the solution.

At 516, the method 500 may include solidifying the solution. Solidifying the solution may include UV light exposure, drying, and/or cooling. In this way, the overhang area may be filled with the hardened solution and reduce mechanical stress experienced by the anode electrode.

Turning now to FIG. 6, it shows an example method 600 of manufacturing a solid-state battery. In one example, the method 600 corresponds to the examples shown in FIGS. 3 and 4, wherein the tabs of the battery are not covered prior to exposing the solid-state battery to the solution. In this way, the method 600 may include fewer steps than the method 500 of FIG. 5.

At 602, the method 600 may include stacking the electrodes together. As such, the anode electrodes and the cathode electrodes may be stacked and their layers alternately arranged such that the anode electrodes do not contact the cathode electrodes.

At 604, the method 600 may include fixing a position of the electrodes. The position of the electrodes may be fixed via a removable tape, a strap, or other fastening device.

At 606, the method 600 may include dipping the electrode stack in the solution. In one example, the solution is a gel. In another example, the solution is a glue. In this way, a first side of the electrode stack is dipped into the solution without covering the tabs. By doing this, a manufacturing step may be omitted and material consumption may be reduced.

At 608, the method 600 may optionally include removing excess solution from the electrode stack. Excess solution may be removed from areas outside of the overhang area of the electrode stack.

At 610, the method 600 may include solidifying the solution. As such, the solution on the first side of the electrode stack is hardened prior to dipping the second side of the electrode stack in the solution.

At 612, the method 600 may include dipping the second side of the electrode stack in the solution. The tabs are left uncovered as the fill line of the container prevents the solution from reaching the tabs.

At 614, the method 600 may optionally include removing excess solution from the electrode stack. The excess solution may be removed from areas outside of the overhang area. Additionally or alternatively, the solution removal may be conducted such that the solution of the second side substantially matches the solution on the first side of the electrode stack.

At 616, the method 600 may include solidifying the solution. As such, the solution on the second side is hardened and both sides of the overhang area include hardened solution configured to support the anode electrode stacks.

Turning now to FIG. 7, it shows an example method 700 of manufacturing a solid-state battery. In one example, the method 700 differs from the method 600 in that the solution is applied to only a desired region of the solid-state battery, such as only the overhang area. By doing this, the step of removing excess solution from the solid-state battery may be omitted.

At 702, the method 700 may include stacking the electrodes together. As such, the anode electrodes and the cathode electrodes may be stacked and their layers alternately arranged such that the anode electrodes do not contact the cathode electrodes.

At 704, the method 700 may include fixing a position of the electrodes. The position of the electrodes may be fixed via a removable tape, a strap, or other fastening device.

At 706, the method 700 may include applying the solution to only the overhang area of a first side of the electrode stack via injection or extrusion. In one example, only the overhang area which includes a void and/or empty space adjacent to the anode electrode stack may receive the solution. By doing this, material consumption of the solution may be reduced and manufacturing efficiency may be increased.

At 708, the method 700 may include solidifying the solution. As such, the solution in the overhang area of the first side of the electrode stack is hardened prior to applying solution to the overhang area of a second side.

At 710, the method 700 may include applying the solution to only the overhang area of the second side of the electrode stack via injection or extrusion.

At 712, the method 700 may include solidifying the solution. The overhang areas on both sides of the solid-state battery may include hardened solution configured to support the anode electrode stacks and mitigate mechanical stresses experienced, which may increase a longevity of the battery.

In one example, the first side and the second side of the electrode stacks correspond to longitudinal sides of stacks that do not include the tabs. Optionally, the method 700 may further include exposing third and fourth sides of the electrode stacks that include the tabs to the solution via injection or extrusion. The tabs may be uncovered prior to the injection or extrusion of the third side and the fourth side to the solution. The increased accuracy of the injection or extrusion may mitigate solution in contact with the tabs. Each of the third side and the fourth side may each include at least one tab and correspond to short sides of the stacks normal to the first and second sides.

In this way, stress experienced by the overhang area of the separator and the anode stack is reduced. Bending or other degradation-inducing movements may be reduced, which may increase a longevity of the solid-state battery.

The disclosure also provides support for a solid-state battery including: a solution at least partially filling an overhang area between an anode electrode stack and a cathode electrode stack. A first example of the system further includes where the solution is hardened. In a second example of the system, optionally including the first example, the solution is non-conductive. In a third example of the system, optionally including one or both of the first and second examples, the solution completely fills the overhang area. In a fourth example of the system, optionally including one or more or each of the first through third examples, the solution is a gel. In a fifth example of the system, optionally including one or more or each of the first through fourth examples, the solution is a glue. In a sixth example of the system, optionally including one or more or each of the first through fifth examples, the overhang area is an area between layers of solid-state electrolyte of the anode electrode stack void of the cathode electrode stack.

The disclosure also provides support for a system for a solid-state battery including a first anode electrode stack, a second anode electrode stack, and a cathode electrode stack, wherein the first anode electrode stack is separated from the cathode electrode stack via a first solid-state electrolyte, and wherein the second anode electrode stack is separated from the cathode electrode stack via a second solid-state electrolyte, and a support arranged in an overhang area between the first solid-state electrolyte and the second solid-state electrolyte. A first example of the system further includes where the support is a hardened solution. In a second example of the system, optionally including the first example, the support is arranged only in the overhang area. In a third example of the system, optionally including one or both of the first and second examples, the support fills the overhang area. In a fourth example of the system, optionally including one or more or each of the first through third examples, the support extends to axial surfaces of the first anode electrode stack and the second anode electrode stack. In a fifth example of the system, optionally including one or more or each of the first through fourth examples, the support extends to axial surfaces of a current collector of the first anode electrode stack and the second anode electrode stack. In a sixth example of the system, optionally including one or more or each of the first through fifth examples, the support does not contact tabs of the solid-state battery. In a seventh example of the system, optionally including one or more or each of the first through sixth examples, the first anode electrode stack, the second anode electrode stack, the cathode electrode stack, and the support are sealed in a pouch.

The disclosure also provides support for a method including stacking a plurality of battery electrodes and separator layers together into an electrode stack, immersing the electrode stack in a solution until an overhang area between separator layers and electrodes is filled, and solidifying the solution on the electrode stack. In a first example of the method, the solution is an ultraviolet (UV) curable compound, a solvent-based solution, or a hot melt-based gel. In a second example of the method, optionally including the first example, the method further includes removing excess solution from the electrode stack prior to solidifying the solution on the electrode stack. In a third example of the method, optionally including one or both of the first and second examples, the method further includes where the solidifying comprises UV light exposure, drying the solution, or cooling. In a fourth example of the method, optionally including one or more or each of the first through third examples, the method further includes covering tabs of the electrode stack prior to immersing the electrode stack in the solution.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A solid-state battery, comprising:
a solution at least partially filling an overhang area between an anode electrode stack and a cathode electrode stack.

2. The solid-state battery of claim 1, wherein the solution is hardened.

3. The solid-state battery of claim 1, wherein the solution is non-conductive.

4. The solid-state battery of claim 1, wherein the solution completely fills the overhang area.

5. The solid-state battery of claim 1, wherein the solution is a gel.

6. The solid-state battery of claim 1, wherein the solution is a glue.

7. The solid-state battery of claim 1, wherein the overhang area is an area between layers of solid-state electrolyte of the anode electrode stack void of the cathode electrode stack.

8. A system for a solid-state battery, comprising:
a first anode electrode stack, a second anode electrode stack, and a cathode electrode stack, wherein the first anode electrode stack is separated from the cathode electrode stack via a first solid-state electrolyte, and wherein the second anode electrode stack is separated from the cathode electrode stack via a second solid-state electrolyte; and
a support arranged in an overhang area between the first solid-state electrolyte and the second solid-state electrolyte.

9. The system of claim 8, wherein the support is a hardened solution.

10. The system of claim 8, wherein the support is arranged only in the overhang area.

11. The system of claim 8, wherein the support fills the overhang area.

12. The system of claim 8, wherein the support extends to axial surfaces of the first anode electrode stack and the second anode electrode stack.

13. The system of claim 8, wherein the support extends to axial surfaces of a current collector of the first anode electrode stack and the second anode electrode stack.

14. The system of claim 8, wherein the support does not contact tabs of the solid-state battery.

15. The system of claim 8, wherein the first anode electrode stack, the second anode electrode stack, the cathode electrode stack, and the support are sealed in a pouch.

16. A method, comprising:
stacking a plurality of battery electrodes and separator layers together into an electrode stack;
immersing the electrode stack in a solution until an overhang area between separator layers and electrodes is filled; and
solidifying the solution on the electrode stack.

17. The method of claim 16, wherein the solution is an ultraviolet (UV) curable compound, a solvent-based solution, or a hot melt-based gel.

18. The method of claim 16, further comprising removing excess solution from the electrode stack prior to solidifying the solution on the electrode stack.

19. The method of claim 16, wherein the solidifying comprises UV light exposure, drying the solution, or cooling.

20. The method of claim 16, further comprising covering tabs of the electrode stack prior to immersing the electrode stack in the solution.
